(19) United States
(12) Patent Application Publication
(10) Pub. No.: US 2012/0092636 A1
(43) Pub. Date: Apr. 19, 2012

(54) Metrology Apparatus, Lithography Apparatus and Method of Measuring a Property of a Substrate

(75) Inventors: Karel Diederick Van Der Mast, Helmond (NL); Nicolaas Antonius Allegondu Van Asten, Breda (NL); Arie Jeffrey Den Boef, Waalre (NL); Marcus Adrianus Van De Kerkhof, Helmond (NL)

(73) Assignee: ASML Netherlands B.V., Veldhoven (NL)

(21) Appl. No.: 13/263,216

(22) PCT Filed: Apr. 30, 2009
(86) PCT No.: PCT/EP09/03155

§ 371 Date: Jan. 4, 2012

(51) Int. Cl. G03B 27/54; G01N 21/55

(52) U.S. Cl. 355/67; 356/445

(57) ABSTRACT

A metrology apparatus is configured to measure a property of a substrate. The metrology apparatus includes an illumination system configured to condition a radiation beam, an objective lens configured to project radiation onto the substrate, a detector configured to detect radiation reflected from a surface of the substrate, and an image field selecting device in the path of the reflected radiation constructed and arranged to select an area of an image field associated with the substrate. The selected area corresponds with a predetermined portion of the substrate. This arrangement may enable selection of different shapes and sizes of targets on the substrate and may enable in-die measurement of selected parameters.

### FIELD

The present invention relates to methods of metrology usable, for example, in the manufacture of devices by lithographic techniques and to methods of manufacturing devices using lithographic techniques.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to monitor the lithographic process, parameters of the patterned substrate, for example the overlay error between successive layers formed in or on it should be measured. There are various techniques for making measurements of the microscopic structures formed in lithographic processes, including the use of scanning electron microscopes and various specialized tools. One form of specialized metrology tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometer are known. Spectroscopic scatterometers direct a broadband radiation beam onto the substrate and measure the spectrum (intensity as a function of wavelength) of the radiation scattered into a particular narrow angular range. Angularly resolved scatterometers use successively, or in parallel, a monochromatic radiation beam and measure the intensity of the scattered radiation as a function of angle.

For overlay measurements on targets inside a portion of the substrate where subsequent layers of integrated circuits should be measured, the so-called in-die measurement, the size of the targets should be reduced further, as compared to the presently used 30×30 μm, 40×40 μm or similar scribe-line markers.

### SUMMARY

It is desirable to provide a metrology apparatus which enables measurement on smaller and larger targets, e.g. in-die measurements outside the scribe lane areas as well as larger markers in the scribe lane areas.

According to an aspect of the invention, there is provided a metrology apparatus that is configured to measure a property of a substrate. The metrology apparatus includes an illumination system configured to condition a radiation beam, an objective lens configured to project radiation onto the substrate, a detector configured to detect radiation reflected from a surface of the substrate, and an image field selecting device in the path of the reflected radiation constructed and arranged to select an area of an image field associated with the substrate. The selected area corresponds with a predetermined portion of the substrate.

According to an aspect of the invention, there is provided a lithographic apparatus that includes a metrology apparatus that is configured to measure a property of a substrate. The metrology apparatus includes an illumination system configured to condition a radiation beam, an objective lens configured to project radiation onto the substrate, a detector configured to detect radiation reflected from a surface of the substrate, and an image field selecting device in the path of reflected radiation constructed and arranged to select an area of an image field associated with the substrate. The selected area corresponds with a predetermined portion of the substrate.

According to a further aspect of the invention there is provided a method of measuring a property of a substrate. The method includes projecting radiation onto a substrate, and detecting radiation reflected from the substrate. The reflected radiation is indicative of the property to be measured. The method also includes associating an image field with the substrate, and selecting a portion of the image field corresponding with a predetermined portion of the substrate for detecting the reflected radiation from the corresponding portion of the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a depicts an embodiment of a lithographic apparatus;

FIG. 1b depicts an embodiment of a lithographic cell or cluster;

FIG. 2 depicts an embodiment of a scatterometer;

FIG. 3 depicts an embodiment of a scatterometer;

FIG. 4 depicts an embodiment of a scatterometer;

FIG. 5 depicts an embodiment of a wheel provided with different apertures that may be used with the scatterometer of FIG. 4;

FIG. 6 depicts an embodiment of an iris diaphragm that may be used with the scatterometer of FIG. 4;

FIG. 7 depicts an embodiment of a scatterometer; and

FIG. 8 depicts an embodiment of a scatterometer.

### DETAILED DESCRIPTION

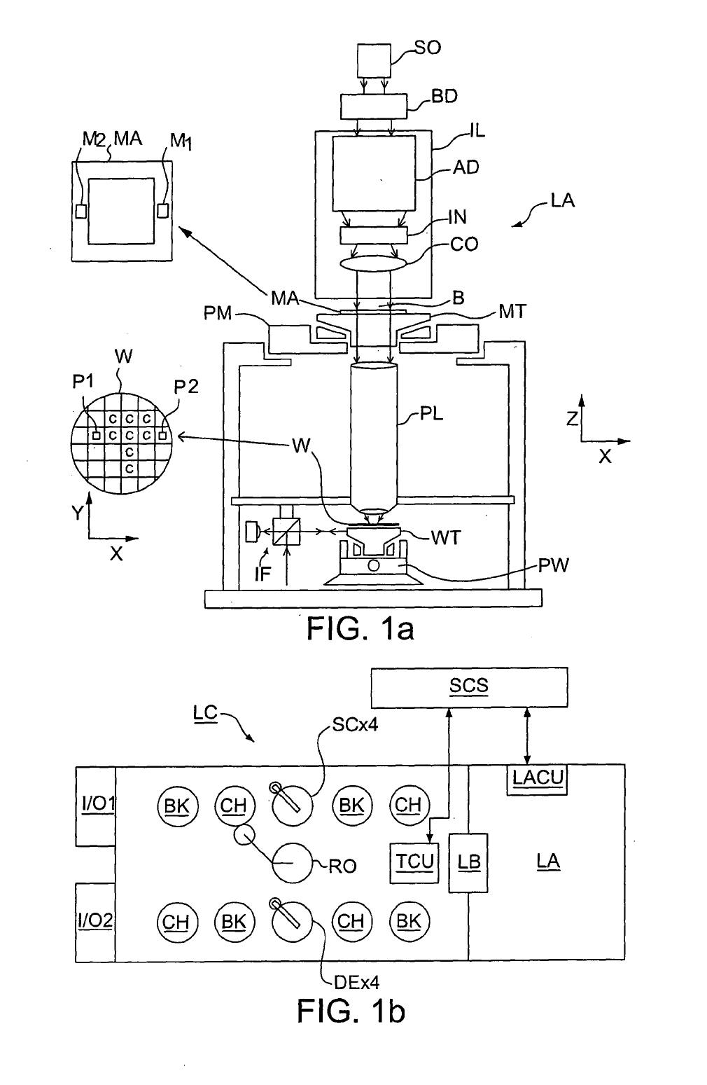

FIG. 1 schematically depicts a lithographic apparatus. The apparatus comprises an illumination system (illuminator) IL configured to condition a radiation beam B (e.g. UV radiation or DUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PL configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1a, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g. an interferometric device, linear encoder, 2-D encoder or capacitive sensor), the substrate table WT can be moved accurately, e.g. so as to position different target portions C in the path of the radiation beam B. Similarly, the first positioner PM and another position sensor (which is not explicitly depicted in FIG. 1a) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 1b, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the metrology can be done soon and fast enough that other substrates of the same batch are still to be exposed. Also, already exposed substrates may be stripped and reworked—to improve yield—or discarded—thereby avoiding performing exposures on substrates that are known to be faulty. In a case where only some target portions of a substrate are faulty, further exposures can be performed only on those target portions which are good.

A metrology apparatus is used to determine the properties of the substrates, and in particular, how the properties of different substrates or different layers of the same substrate vary from layer to layer. The metrology apparatus may be integrated into the lithographic apparatus LA or the lithocell LC or may be a stand-alone device. To enable most rapid measurements, it is desirable that the metrology apparatus measure properties in the exposed resist layer immediately after the exposure. However, the latent image in the resist has a very low contrast—there is only a very small difference in refractive index between the parts of the resist which have been exposed to radiation and those which have not—and not all metrology apparatus have sufficient sensitivity to make useful measurements of the latent image. Therefore measurements may be taken after the post-exposure bake step (PEB) which is customarily the first step carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

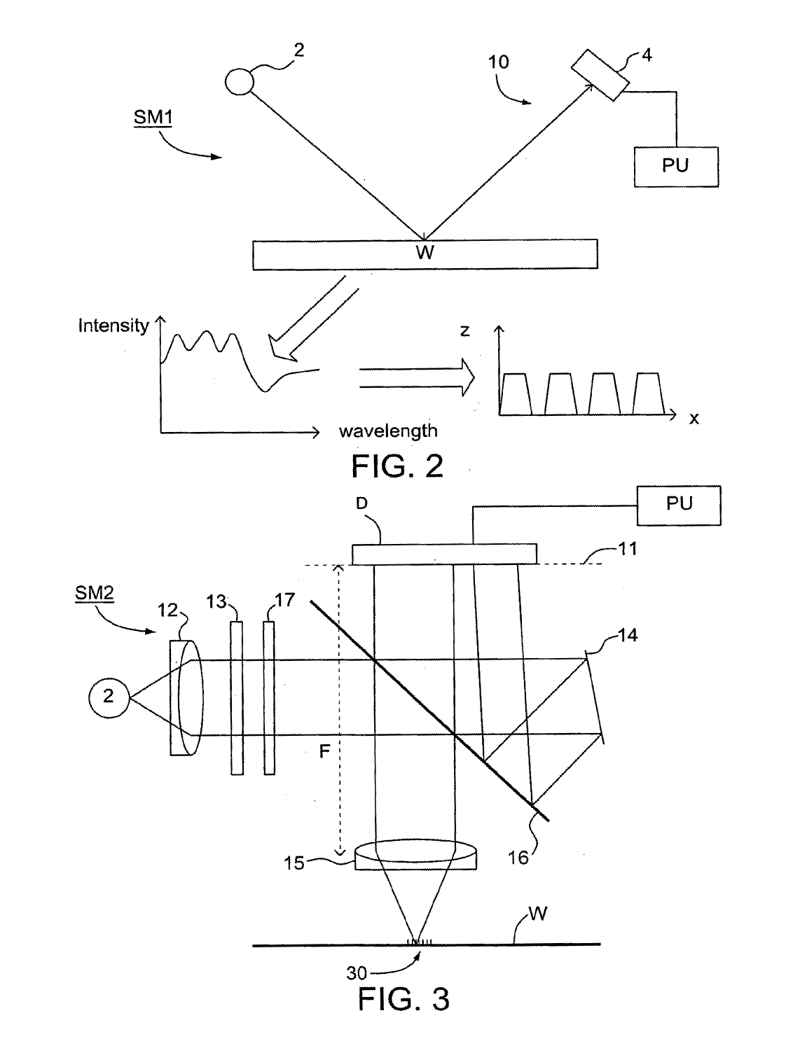

FIG. 2 depicts a scatterometer SM1 for use as a metrology apparatus. It comprises a broadband (white light) radiation projector 2 which projects radiation onto a substrate W. The reflected radiation is passed to a spectrometer detector 4, which measures a spectrum 10 (intensity as a function of wavelength) of the specular reflected radiation. From this data, the structure or profile giving rise to the detected spectrum may be reconstructed by processing unit PU, e.g. by Rigorous Coupled Wave Analysis and non-linear regression or by comparison with a library of simulated spectra as shown at the bottom of FIG. 2. In general, for the reconstruction, the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

FIG. 3 depicts an embodiment of a scatterometer SM2 for use as a metrology apparatus. The scatterometer SM2 is provided with a radiation source 2, a lens system 12, interference filter 13, partial reflecting surface 16 and microscope objective lens 15. The objective lens 15 has a high numerical aperture (NA), such as at least 0.9, or at least 0.95. Immersion scatterometers may even have lenses with numerical apertures over 1. Furthermore, the scatterometer SM2 is provided with a detector D. In operation, the radiation emitted by radiation source 2 is focused using lens system 12 through an interference filter 13 and a polarizer 17, is reflected by a partially reflected surface 16 and is focused onto a substrate W via a microscope objective lens 15. The reflected radiation then transmits through the partially reflective surface 16 into the detector D in order to have the scatter spectrum detected. The detector D may be located in the back-projected pupil plane 11, which is at the focal length F of the lens system 15, however the pupil plane may instead be re-imaged with auxiliary optics (not shown) onto the detector D. The pupil plane is the plane in which the radial position of radiation defines the angle of incidence and the angular position defines azimuth angle of the radiation. The detector D may be a two-dimensional detector so that a two-dimensional angular scatter spectrum of a substrate target 30 can be measured. The detector D may be, for example, an array of CCD or CMOS sensors, and may use an integration time of, for example, 40 milliseconds per frame.

A reference beam may be used for example to measure the intensity of the incident radiation. To do this, when the radiation beam is incident on the beam splitter 16 part of it is transmitted through the beam splitter as a reference beam towards a reference mirror 14. The reference beam is then projected onto a different part of the same detector D.

A set of interference filters 13 may be used to select a wavelength of interest in the range of, for example, 405-790 nm or even lower, such as 200-300 nm. The interference filter may be tunable rather than comprising a set of different filters. A grating may be used instead of interference filters.

The detector D may measure the intensity of scattered light at a single wavelength (or narrow wavelength range), the intensity separately at multiple wavelengths or integrated, either sequentially or parallel over a wavelength range. The detector may separately measure the intensity of transverse magnetic- and transverse electric-polarized light and/or the phase difference between the transverse magnetic- and transverse electric-polarized light.

A broadband light source (i.e. one with a wide range of light frequencies or wavelengths—and therefore of colors) that gives a large etendue may be used, thereby allowing the mixing of multiple wavelengths. The plurality of wavelengths in the broadband may each have a bandwidth of Δλ and a spacing of at least 2 Δλ (i.e. twice the bandwidth). Several “sources” of radiation can be different portions of an extended radiation source which have been split using fiber bundles. In this way, angle resolved scatter spectra can be measured at multiple wavelengths in parallel. A 3-D spectrum (wavelength and two different angles) can be measured, which contains more information than a 2-D spectrum. This may allow more information to be measured which increases metrology process robustness. This is described in more detail in European Patent Application Publication No. 1,628,164A.

The target 30 on substrate W may be a grating, which is printed such that after development, the bars are formed of solid resist lines. The bars may alternatively be etched into the substrate. This pattern is sensitive to chromatic aberrations in the lithographic projection apparatus, particularly the projection system PL, and illumination symmetry and the presence of such aberrations may manifest themselves in a variation in the printed grating. Accordingly, the scatterometry data of the printed gratings may be used to reconstruct the gratings. The parameters of the grating, such as line widths and shapes, may be input to the reconstruction process, performed by processing unit PU, from knowledge of the printing step and/or other scatterometry processes.

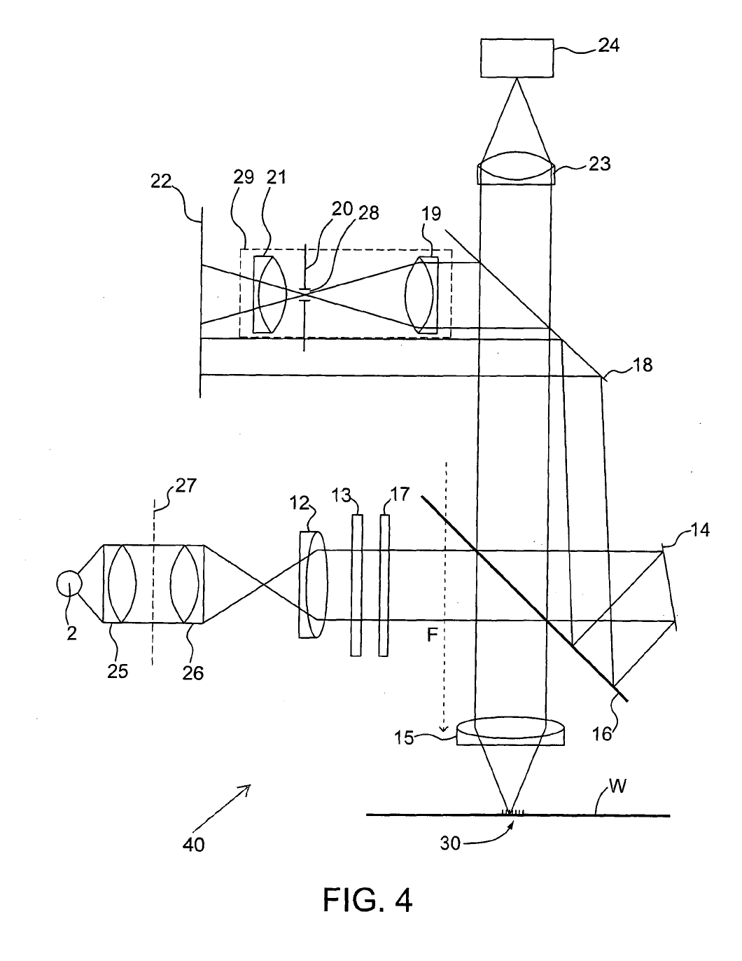

FIG. 4 depicts an embodiment of a scatterometer 40 having an image field selecting device (selector) 29 for use as a metrology apparatus. The scatterometer 40 comprises, in this order, a light source 2, a lens system 25, 26, an illumination defining aperture 27, a lens 12, an interference filter 13 and a polarizer 17, a beam splitting element 16 and an objective lens 15. The objective lens 15 may be a high NA lens, for example, having an NA of 0.9. The light source can be a UHP lamp, an incandescent lamp or a “white light” laser. The UHP lamp should be suitable for emitting radiation with for example wavelengths in the range between 180 to 800 nm. The scatterometer 40 may further comprise a further beamsplitter 18 and an image sensor 22 (detector). The image field defining device 29 comprises lenses 19, 21 and a blade 20 provided with an aperture 28. The lenses 19, 21 create an image of the substrate in the plane where the aperture 28 is positioned. In an embodiment, the lenses 19, 21 may be omitted.

In operation, the light source 2 emits a radiation beam to a target portion 30 on the substrate W via the lens element 25, the illumination defining aperture 27, the lens elements 26, 12, the interference filters 13, the polarizer 17, the beam splitting element 16 and the objective lens 15. The illumination defining aperture 27 may be an annular aperture for 1^{st} order overlay measurements or circular aperture for 1^{st} order overlay and critical dimension (CD) reconstruction respectively. Depending on the size of the target 30, different sizes of the annular ring or radii of the circular apertures can be selected. The illuminated target 30 on the substrate W scatters zero and higher orders of the impinging beam to the image sensor 22 via the objective lens 15, the beam splitting elements 16,18, the lens 19, the aperture 28 and the lens 21. The image sensor 22 can be a CCD or a CMOS image sensor. Conventionally, the spot geometry of the impinging beam defines the shape of the illuminated area, which contributes to the pupil shape of the pupil plane of the objective lens 15. The illuminated area may have circular dimensions for example with a radius of 25 μm. The lenses 21,19 positioned between the objective lens 15 and the image sensor 22 image the pupil plane of the objective lens 15 on the image sensor 22. The lens 19 creates an intermediate image of the substrate between the lenses 19, 21. The intermediate plane is the conjugate plane associated with the wafer surface. In this embodiment, the aperture 28 is positioned in the intermediate image. The aperture 28 selects a portion of the image field corresponding to a predetermined target 30 of the wafer W from which a CD or overlay measurement has to be obtained. This portion may then only contributes to the pupil plane information. In embodiments wherein the lenses 19, 21 are not applied, the aperture 28 should be positioned in the image plane of the objective lens 15.

In this embodiment, similar to the embodiment described in relation with FIG. 3, a reference beam are present is for calibration of the image sensor 22. The reference beam is split off from the illumination beam via the second beam splitting element 16 and the mirror 14 and directed to the image sensor 22 via the beam splitting elements 16 and 18.

Furthermore, the beam splitting element 18 splits off an alignment beam from the reflected beam from the substrate W and transfers the alignment beam to an image alignment sensor 24 via a lens 23.

By selecting the size and shape of the aperture of the imagefield defining device 29, the contribution to the pupil plane information may be changed in a flexible way. This flexibility may allow for optimal results, in terms of measurement speed, accuracy and reproducibility etc.

The magnification between the wafer plane and the intermediate image field is fixed and is, for example 30 times. In an embodiment, the diameter of the aperture 28 may be selected to be 150 μm. With a magnification of 30×, the diameter of a target on the wafer surface is equal to 5 μm. In practice, the grating targets 30 in a scribe lane between adjacent dies on the substrate W have dimensions of, for example, 40×40 μm and the dimensions of the illumination spot on the substrate has a diameter of, for example, 25 μm. In that example, the target is said to be under filled by the illumination beam. When this embodiment is operated with an illumination spot with a diameter of 12 μm on the substrate for measuring of a 20×20 μm target on the substrate W, the illumination spot may difficult to align with the target 30 at the substrate W.

In conventional scatterometers, the minimum target area may be limited by the spot size obtained with the illumination beam and contributions from alignment, vibrations, and optical side lobes. A 20×20 μm target area at the substrate W can be selected through an image field selecting device 29 provided with a circular aperture 28 of 360 μm diameter. The image field selecting device 29 that is provided with apertures of this size may be aligned with the substrate more easily, as compared with the alignment of the 12 μm diameter of the illumination beam spot at the substrate W. By selecting different diameters and shapes of the aperture 28 of the image field selecting device 29, a large range of dimensions of targets on the substrate W and measurement at grating targets in the scribe lane area of the substrate as well as targets inside an area of a single die on the substrate W may be enabled. In this arrangement, most of the surface of the target can be used for the measurement which may lead to higher throughput because of the higher intensities used in the measurements.

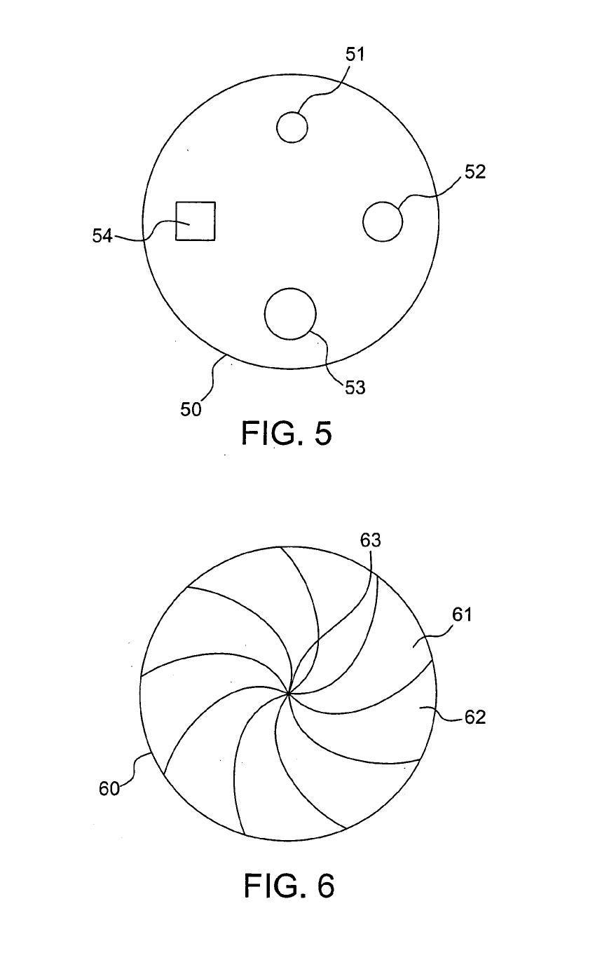

FIG. 5 depicts an embodiment of a moveable plate, for example a rotatable wheel 50 for use in an embodiment of the scatterometer as described herein. The rotatable wheel 50 may be provided with three circular apertures 51, 52, 53 of different sizes, respectively, and a square aperture 54. The rotatable wheel can be rotated by a stepper motor.

FIG. 6 depicts an embodiment of an iris diaphragm 60 for use in an embodiment of the scatterometer as described herein. The iris diaphragm 60 comprises moveable blades 61,62. The positions of the individual blades 61, 62 determine the size of an aperture 63 at or near the center of the diaphragm 60. The positions of the individual blades may be adjusted with a stepper motor. The iris diaphragm 60 may be adapted to a large range of diameters and can be integrated in a compact way in a scatterometer.

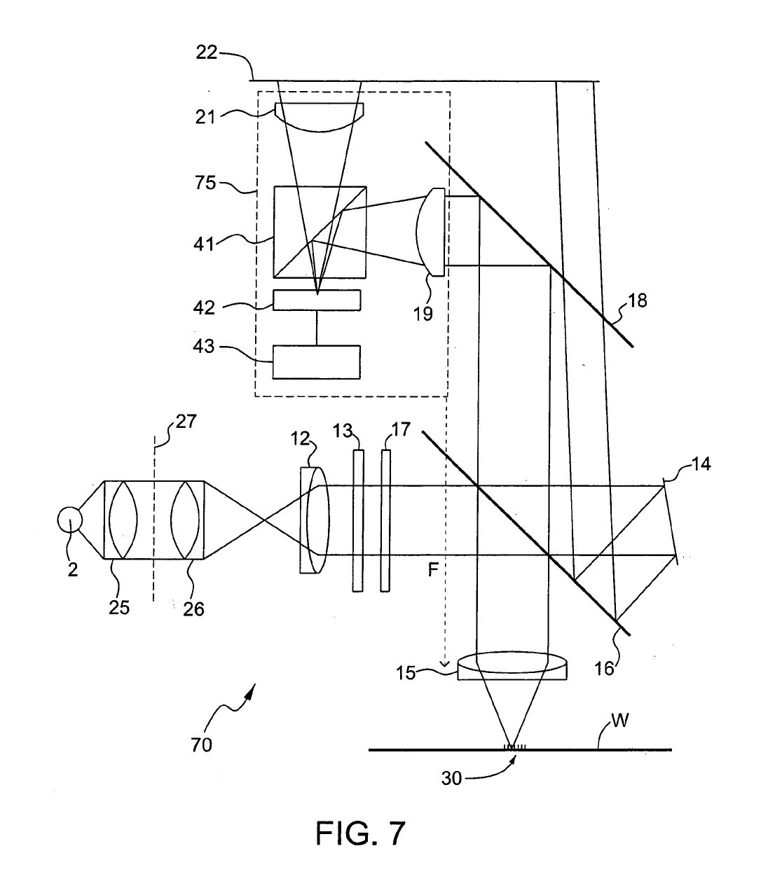

FIG. 7 depicts an embodiment of a scatterometer 70 with an image field selecting device 75. The scatterometer 70 may comprise in this general order a light source 2, a lens system 25, 26, an illumination defining aperture 27, a lens 12, an interference filter 13, a polarizer 17, a beam splitting element 16, an objective lens 15, a beam splitting element 18, the image field selecting device 75, and an image sensor 22. The light source can be a UHP lamp suitable for emitting radiation with wavelengths in the range between 180 to 800 nm. In an embodiment, an incandescent lamp or a “white light” laser can be applied. The objective lens may by a high-NA lens, e.g. an NA of 0.90 or 0.95.

The image field selecting device 75 may comprise a lens 19, a total internal reflection (TIR) prism 41, an adjustable mirror array 42, and a lens 21. The image field selecting device may also comprise a controller 43 configured to adjust the adjustable mirror array 42. The adjustable mirror array can be a digital mirror device, for example, an XGA DLP chip as can be obtained from Texas Instruments. Also other kind of spatial light modulators (SLM) or Micro-Electronic-Mechanical-System (MEMS) can be used instead of the adjustable mirror array 42. In an embodiment, the lenses 19, 21 can be omitted; the digital mirror device should then be positioned at the image plane of the objective lens.

In operation, the light source 2 emits a radiation beam to a target portion 30 on the substrate W via the lens elements 25, the illumination defining aperture 27, the lens element 26, 12, the interference filter 13, the polarizer 17, the beam splitting element 16 and the objective lens 15. The illumination defining aperture 27 may be an annular aperture for 1^{st} order overlay measurements and a circular aperture for measurements based on critical (CD) reconstruction. Depending on the size of the target 30 on the substrate W, different sizes of the annular ring or radii of the circular apertures can be selected. The illuminated target 30 on the substrate W scatters zero and higher orders of the impinging beam to the image sensor 22 via the objective lens 15, the beam splitting elements 16, 18, the lens 20, the image field selecting device 75 and the lens 21. The image sensor 22 can be, for example, a CCD or a CMOS image sensor.

The spot geometry of the impinging beam may define the shape of the illuminated area, which contributes to the pupil shape of the pupil plane of the 15. The illuminated area may have a circular dimension with, for example, a 25 μm diameter. The lenses 19,21 image this pupil plane on the image sensor 22. The lens 19 creates an image field plane between the lenses 21, 19.

The controller 43 in a first step may obtain via a user interface the dimension and position of the portion of the imagefield plane that corresponds to the selected target 30 at the substrate W. In a further step, the controller 43 may adjust the position of a first group of digital mirrors of the digital mirror device 42 such that the angle of the beams corresponding to selected portion of the intermediate image field is smaller than the Brewster angle of the interface inside the TIR prism 41 and the reflected portion of the beams are directed to the image sensor 22 via the TIR prism 41 and the lens 21. The controller 43 may adjust a second group of digital mirrors of the digital mirror device 42 such that the beam corresponding to the non-selected portion of the target area are directed to a beam dump (not shown).

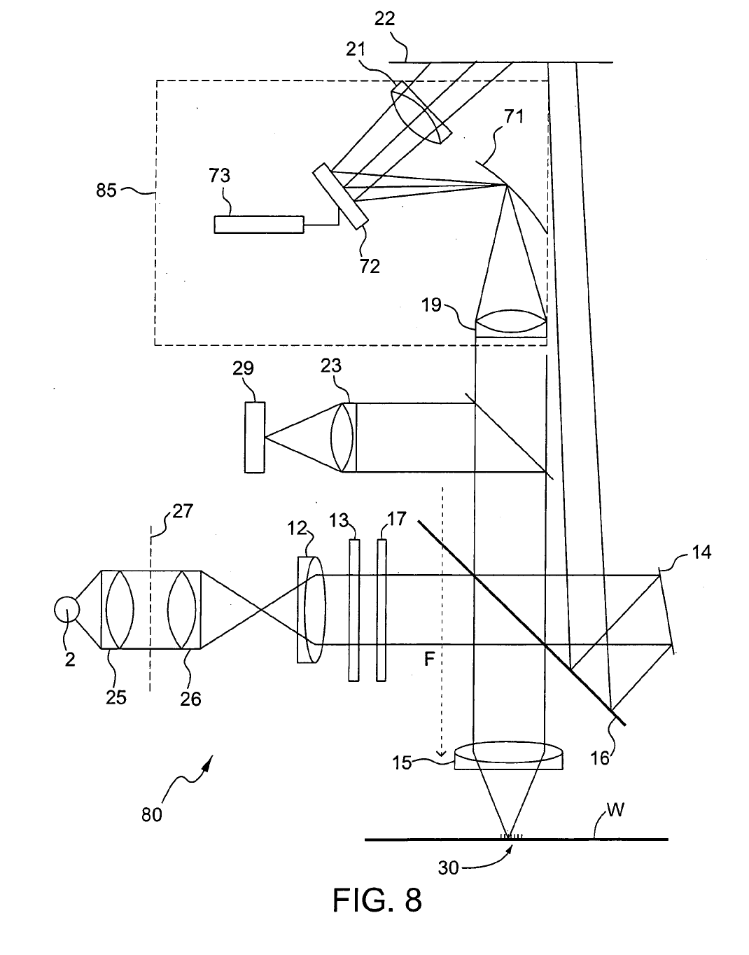

FIG. 8 depicts an embodiment of a scatterometer 80 with an image field selecting device 85. The scatterometer 80 comprises in this general order a light source 2, a lens system 25, 26, an illumination defining aperture 27, a lens 12, an interference filter 13, a polarizer 17, a beam splitting element 16, an objective lens 15, a beam splitting element 18, the image field selecting device 85, and an image sensor 22. The light source 2 can be a UHP lamp suitable for emitting radiation with wavelengths in the range between 300 to 800 nm. In an embodiment, an incandescent lamp or a white light laser can be applied. The objective lens can be a high NA objective lens, e.g., with an NA of 0.90 or 0.95. The image field selecting device 85 may comprise a lens 19, a concave mirror 71, am adjustable mirror array 72, and a lens 21. The image field selecting device 85 may also comprise a controller 73 configured to adjust the adjustable mirror array 72. The adjustable mirror array can be a digital mirror device for example, an XGA DLP chip as can be obtained from Texas Instruments. Also other kinds of spatial light modulators (SLM) or Micro-Electronic-Mechanical-System (MEMS) can be used instead of the adjustable mirror array 42. In an embodiment, the lenses 19, 21 can be omitted; the digital mirror device should then be positioned at the image plane of the objective lens.

In operation, the light source 2 emits a radiation beam to a target portion 30 on the substrate W via the lens elements 25, the illumination defining aperture 27, the lens element 26, 12, the interference filter 13, the polarizer 17, the beam splitting element 16, and the objective lens 15. The illumination defining aperture 27 may be an annular aperture for 1^{st} order overlay measurement or a circular aperture for measurements for critical (CD) reconstruction. Depending on the size of the target 30 on the substrate W, different sizes of the annular ring or radii of the circular apertures can be selected. The illuminated target 30 on the substrate W scatters zero and higher orders of the impinging beam to the image sensor 22 via the lens 15 the beam splitting elements 16,18, and the image field selecting device 85. Conventionally, the spot geometry of the impinging beam defines the shape of the illuminated area, which contributes to the pupil shape of the pupil plane of the 15. The illuminated area may have circular dimensions of, for example, 25 μm diameter. Other shapes are for example rectangular or square. The lenses 21,19 image this pupil plane on the image sensor 22. The image sensor 22 can be, for example, a CCD or a CMOS image sensor. The controller 73 in a first step may obtain via a user interface (not shown) the dimension and position of the portion of the imagefield plane that corresponds to the selected target 30 at the substrate W. In a further step, the controller 73 may adjust a first group of digital mirrors of the digital mirror device 72 such that the beams corresponding to selected portion of the intermediate image field are directed to the image sensor 22 via the lens 21, and adjust a second group of digital mirrors of the digital mirror device 72 such that the second group of digital mirrors direct the beams corresponding to the non-selected portion of the target area to a beam dump (not shown).

In a further embodiment the image field defining element 75 is arranged to define an area in the image field associated with a second predetermined portion on the substrate W so that the first and second predetermined portions overlap and the second predetermined area (not shown) is smaller than the first predetermined portion 30.

In the embodiments described herein, the image field selecting device in the measurement beam can be matched with the diameter of the illumination beam in order to improve the measurement accuracy and reduce loss of photons at the measurement beam. For example, an in-die 10×10 μm target can be illuminated with a beam diameter of 30 μm to achieve uniform illumination and the scattered light can be spatially filtered with the image field selecting device in the intermediate image plane.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or a metrology tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A metrology apparatus configured to measure a property of a substrate, the metrology apparatus comprising:
an illumination system configured to condition a radiation beam;
an objective lens configured and arranged to project the conditioned radiation beam on the substrate;
a detector configured to detect radiation reflected from a surface of the substrate; and
an image field selecting device positioned in the path of the reflected radiation, which image field selecting device is constructed and arranged to select an area of an image field associated with the substrate, the selected area corresponding with a portion of the substrate.

2. The metrology apparatus according to claim 1, wherein the image field selecting device comprises an aperture.

3. The metrology apparatus according to claim 2, further comprising an iris diaphragm constructed and arranged to adjust a size of the aperture.

4. The metrology apparatus according to claim 1, wherein the image field selecting device comprises a moveable plate provided with apertures of different shapes constructed and arranged to select predetermined shapes of the corresponding portion on the substrate.

5. The metrology apparatus according to claim 1, wherein the image field, selecting device comprises an adjustable mirror array constructed and arranged to select the predetermined area of the image field associated with a predetermined portion of the substrate.

6. The metrology apparatus according to claim 5, wherein the image field selecting device further comprises a total internal reflectance prism for directing a first beam portion corresponding to selected image field area via the adjustable mirror array towards the detector and for directing a second beam corresponding to a non selected portion of the image field area away from the detector.

7. The metrology apparatus according to claim 1, wherein the image field selecting device comprises a lens system.

8. The metrology apparatus according to claim 1, wherein the metrology apparatus comprises a beam diameter setting device constructed and arranged to define a diameter of an illumination beam for illumination of a first predetermined portion of a substrate.

9. The metrology apparatus according to claim 8, wherein the image field defining element is arranged to define an area in the image field associated with a second predetermined portion on the substrate so that the first and second predetermined portions overlap and the second predetermined area is smaller than the first predetermined portion.

10. The metrology apparatus according to claim 1, wherein the image field selecting device is positioned in the path of the reflected radiation between the substrate and the detector.

11. A lithographic apparatus comprising:
a metrology apparatus configured to measure a property of a substrate, the metrology apparatus comprising:
an illumination system configured to condition a radiation beam;
an objective lens configured to project radiation onto the substrate;
a detector configured to detect radiation reflected from a surface of the substrate; and
an image field selecting device positioned in the path of the reflected radiation constructed and arranged to select an area of an image field associated with the substrate, the selected area corresponding with a predetermined portion of the substrate.

12. A method of measuring a property of a substrate, the method comprising:
projecting radiation onto a substrate;
detecting radiation reflected from the substrate, the reflected radiation being indicative of the property to be measured;
associating an image field with the substrate; and
selecting a portion of the image field corresponding with a predetermined portion of the substrate for detecting the reflected radiation from the corresponding portion of the substrate.
